(19) United States
(12) Patent Application Publication
(10) Pub. No.: US 2002/0122552 A1
(43) Pub. Date: Sep. 5, 2002

(54) Method and system for qualifying subscriber loops for xDSL service

(75) Inventor: Gin Liu, Brampton (CA)

Correspondence Address: SMART AND BIGGAR, 438 UNIVERSITY AVENUE, SUITE 1500 BOX 111, TORONTO, ON, M5G2K8, CA

(73) Assignee: NORTEL NETWORKS LIMITED

(21) Appl. No.: 09/750,070

(22) Filed: Dec. 29, 2000

(51) Int. Cl. H04M 1/00; H04M 9/00; H04M 9/08

(52) U.S. Cl. 379/399.01

(57) ABSTRACT

A method and system for single-ended qualification of subscriber loops for xDSL services is disclosed. Subscriber loop database record are screened for disqualifying devices or services on the loop. If none are found, a set of predetermined electrical characteristics of the subscriber loop are derived from information in the database, or measured using test equipment at a central office end of the subscriber loop. The electrical Characteristics are used to assess the noise margin for the loop. If the assessed noise margin suggests that the loop does not qualify, the loop is modeled to assess if it will qualify in the presence of repeaters. The method and system are particularly well suited for qualifying a loop for HDSL or HDSL2 service.

### FIELD OF THE INVENTION

The invention relates generally to the provision of data services over subscriber loops in the public switched telephone network and, in particular, to a method and apparatus to determine from a single end, the suitability of such loops for the provision of high-speed data services.

### BACKGROUND OF THE INVENTION

The exponential increase in the popularity of the Internet and related data services has prompted service providers in the Public Switched Telephone Network (PSTN) to seek new technologies for delivering high-speed data services to their customers. One solution is provided by Digital Subscriber Line (DSL) technologies. Several DSL technologies offer high-speed services over existing copper telephone lines, commonly referred to as “subscriber loops”. Such technologies include Asymmetrical Digital Subscriber Line (ADSL); High-bit-rate Digital Subscriber Line, and advanced High-bit-rate Digital Subscriber Line (HDSL and HDSL2); Rate Adaptive Digital Subscriber Line (RDSL); Symmetric Digital Subscriber Line (SDSL); ISDN Digital Subscriber Line (IDSL); and, Very High-speed Digital Subscriber Line (VDSL). These digital subscriber line technologies are known collectively as “xDSL” technologies.

Existing subscriber loops, however, have largely not been upgraded since the advent of xDSL. As existing subscriber loops were designed for telephony voice signals they typically include wire gauge changes and bridged taps (unused extension lines) which limit the available bandwidth for xDSL. Similarly, other equipment installed on subscriber loops may also render such loops unsuitable for the provision of xDSL services. For example, load coils, voice frequency repeaters, loop extenders, Private Branch Exchanges (PBXs), line intercepts and incompatible data services all render subscriber loops unsuitable for the provision of xDSL service.

Testing apparatus for determining the physical and/or electrical characteristics of subscriber loops are known. Such apparatus are for example, disclosed in U.S. Pat. No. 4,105,995 which issued Aug. 8, 1978 to Bothof et al.; U.S. Pat. No. 4,870,675 which issued Sep. 26, 1989 to Fuller et al.; and, U.S. Pat. No. 5,881,130 which issued Mar. 9, 1999 to Zhang. While these allow the determination of certain physical and/or electrical characteristics of the subscriber loop, none allow single ended qualification of the subscriber loop for xDSL service.

Consequently, it has been the practice of PSTN service providers to dispatch a skilled technician to the premises of a customer who has requested, or expressed an interest in an xDSL service The technician coordinates testing with another technician at the service provider's Central Office (CO). The dispatch of the skilled technician contributes significantly to the service provider's operating overhead and delays service provision.

In order to reduce the cost and improve the efficiency of subscriber loop qualification, U.S. patent application Ser. No. 09/389,360, the contents of which are hereby incorporated by reference, discloses a method of qualifying a subscriber loop by estimating available bandwidth at this customer premises equipment (CPE) from the subscriber's CO without requiring dispatch of a skilled technician to the subscriber premises. This methods lends itself to automation, and to qualifying multiple lines in bulk.

However, for most existing xDSL technologies, the measure of available bandwidth for a loop may be used to provide xDSL services near the maximum bandwidth supported by the loop. For some xDSL technologies, such as HDSL or HDSL2, however, a reduced bandwidth measurement may indicate that the line is simply unsuitable for that xDSL service. A simple bandwidth measurement and analysis does not assess whether the existing subscriber loop may be readily modified in order to provide the required bandwidth. As such, existing techniques may needlessly disqualify some loops, which could provide xDSL services with minor modifications.

Accordingly, there exists a need to qualify subscriber loops for xDSL service, and for determining if subscriber loops may be enhanced in order to qualify for certain xDSL services.

### SUMMARY OF THE INVENTION

It is therefore an object of the present invention to provide a method of assessing, from a single end, if an otherwise inadequate, subscriber loop may be modified using repeaters to provide certain xDSL services.

It is therefore another object of the present invention to provide a simple and economical method and apparatus for the single ended qualification of subscriber loops for xDSL service.

In accordance with an aspect of the present invention there is provided a method of assessing if a subscriber loop qualifies for xDSL service, the subscriber loop being connected to a public switched telephone network (PSTN) by a switch at a central office (CO). The method includes: modeling a loop representative of said subscriber loop based on electrical characteristics of said subscriber loop determined at said CO to assess performance of said loop when modified with at least one repeater;estimating if said subscriber loop when modified with at least one repeater provides a bandwidth suitable for said xDSL service, using said model.

In accordance with another aspect of the present invention, there is provided a computer implemented method of qualifying a subscriber loop, provisioned with at least one repeater for xDSL services, the subscriber loop being connected to a public switched telephone network (PSTN) by a switch at a central office (CO). The method includes determining a first location for a repeater on said loop upstream of said CO, so that a portion of said loop between said CO and said first repeater qualifies for carrying xDSL signals.

In accordance with yet another aspect of the present invention, there is provided a system for qualifying a subscriber loop for xDSL services if provisioned with at least one repeater, the subscriber loop being connected to a public switched telephone network (PSTN) at a central office (CO). The system includes a processor operable to: determine, from a CO end of the subscriber loop, one or more electrical characteristics of the subscriber loop; and estimate if the subscriber loop when modified with al least one repeater provides a bandwidth suitable for the xDSL service, using the characteristics of the subscriber loop determined by the processor.

In accordance with a further aspect of the present invention, there is provided A computer readable medium storing processor executable instruction, that when loaded at a test system including a processor, adapt the processor to assess if a subscriber loop connected to a public switched telephone network (PSTN) by a switch at a central office (CO) to deliver xDSL services to a customer upstream of the CO, if provisioned with at least one repeater qualifies for xDSL services, by: approximating if a noise margin of a portion of the subscriber loop upstream of a first of the at least one repeater is sufficient for carrying xDSL signals.

In accordance with yet another aspect of the present invention, there is provided A method of determining locations along a subscriber loop for placing repeaters, so that the subscriber loop when provisioned with repeaters qualifies for xDSL services, the subscriber loop being connected to a public switched telephone network (PSTN) by a switch at a central office (CO). The method includes determining a first one of the locations al a maximum distance from the CO, so that a portion of the loop from the CO to the first location has a noise margin sufficient to provide xDSL service.

Other aspects and features of the present invention will become apparent to those of ordinary skill in the art upon review of the following description of specific embodiments of the invention in conjunction with the accompanying figures.

### BRIEF DESCRIPTION OF THE DRAWINGS

The invention will now be explained by way of example only and with reference to the accompanying drawings, in which:

FIG. 1 schematically illustrates a test system, exemplary of an embodiment of the present invention, and in communication with a portion of a public switched telephone network;

FIG. 2 is a schematic diagram showing the interconnection of line cards for providing telephone services, subscriber loops delivering telephone services and the test equipment of FIG. 1;

FIG. 3 is a schematic diagram of a subscriber loop to be qualified;

FIGS. 4-6 illustrate example cabling arrangement used to form subscriber loops, to be qualified using embodiments of the present invention;

FIG. 7 is a schematic diagram of the subscriber loop of FIG. 3;

FIG. 8 is a schematic diagram of a shielded subscriber loop;

FIG. 9 is a connection diagram showing a subscriber loop with a bridge tap;

FIGS. 10A-10C and 11 are flow charts of method exemplary of embodiment of the present invention;

FIG. 12 illustrates an power spectral density mask for an upstream HDSL2 signal; and

FIG. 13 illustrates a power spectral density mask f)r a downstream HDSL2 signal.

### DETAILED DESCRIPTION

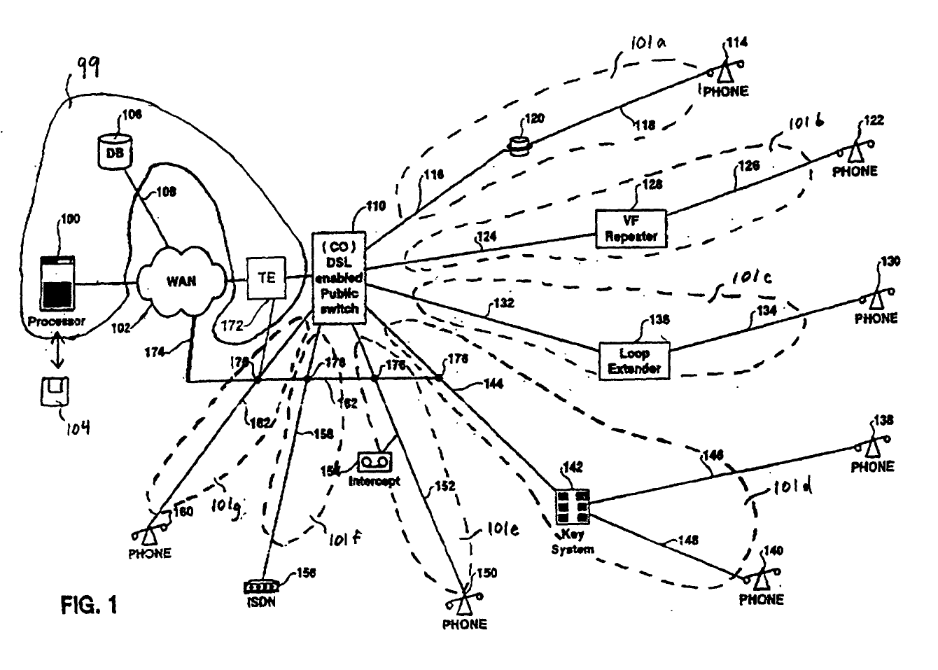

FIG. 1 schematically illustrates a central office (CO) 110 in a switched telephone network connected to a plurality of voice-grade subscriber loops. Exemplary of an embodiment of the present invention, a test system 99 including processor 100, carrier service database 106, and various test equipment 172 is in communication with CO 110. Typically, test equipment 172, database 106 and processor 100 are remotely located from each other and may be in communication by a wide area network (“WAN”) 102. Test system 99 may access CO 110 for qualifying subscriber loops. Test system 99 performs subscriber loop qualification to determine the suitability of the subscriber loops for xDSL services, exemplary of an embodiment of the present invention.

Processor 100 may be a conventional computing device including a processing unit, computer memory, input/output peripherals (possibly including a network interface) under software control to function in manners exemplary of an embodiment of the present invention. Software may be loaded into memory of processor 100 from a conventional computer readable medium 104.

Carrier service database 106 is in communication with WAN 102 by a link 108. Carrier service database 106, could be located it CO 110 or on a server attached to WAN 102 and preferably contains subscriber equipment records that may be indexed by subscriber directory numbers. The carrier service database 106 may store information reflecting the physical characteristics of various associated subscriber loops, such as loop length, wire gauge, bridge taps, etc. Test equipment in communication with other central offices (not shown) providing telephone services to other subscribers, as well as associated database serves may also form part of test system 99 and be addressable by way of WAN 102.

For clarity of illustration seven example subscriber loops 101a-101g are illustrated. Of course, database 106 may contain data representative of many other subscriber loops, which emanate with CO 110, but which are not illustrated.

Telephone services are provided to an example subscriber 114 by way of a subscriber loop 101a divided in two segments 116 and 118. This particular subscriber loop 101a includes a load coil 120 installed between segments 116 and 118. As will be appreciated, load coils such as load coil 120, may be used to improve transmission of signals in the voice frequency band.

Telephone services are provided to another example subscriber 122 by way of a subscriber loop 101b formed of two segments 124 and 126. Installed between subscriber loop segment 124 and subscriber loop segment 126 is a voice frequency repeater 128. Voice frequency repeaters may amplify and retransmit signals in the voice frequency band.

Telephone services are provided to subscriber 130 by way of a subscriber loop 101c divided into two segments 132 and 134. Installed between loop segments 132 and 134 is a loop extender 136. Loop extenders are used to amplify signals in the voice frequency band.

Telephone services are provided to further exemplary subscribers 138 and 140 connected to a key system 142 by link 144 of subscriber loop 101d. Subscribers 138 and 140 are connected to the key system 142 by links 146 and 148. Key systems are used to connect private telephone networks to the public switched telephone network.

Intercepted telephone services are provided to another example subscriber 150 by subscriber loop 101e. Installed on subscriber loop 101e is a recording system 154 which records voice frequency payload carried by the subscriber loop 101e.

Integrated Services Digital Network (ISDN) services are provided to subscriber 156 over subscriber loop 101f.

Plain Old Telephone Service (POTS) voice-grade telephone service is provided to a subscriber 160 by a single segment subscriber loop 101g.

As will be appreciated by a person of ordinary skill of the illustrated subscriber loops, only subscriber loop 101g may be suitable for carrying xDSL services. All others of the subscriber loops contain devices or support services that are incompatible with xDSL services.

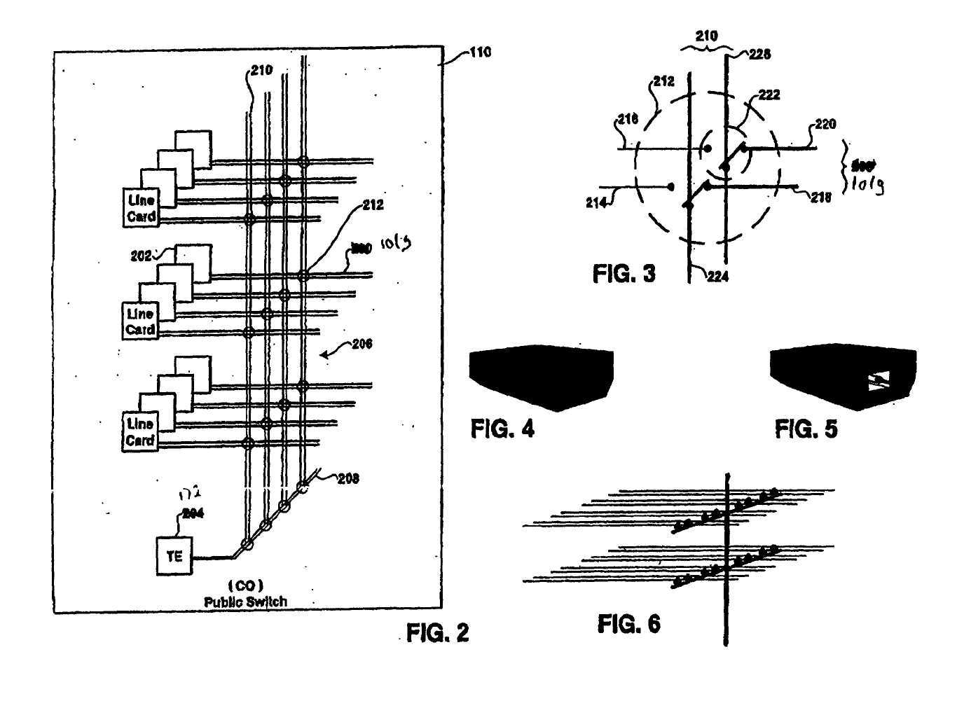

FIG. 2 it is a schematic diagram showing a portion of the CO 110 which serving subscriber loop 101g terminated on line cards 202. Test equipment 172 can be connected to individual subscriber loops, including loop 101g through an access grid 206 which consists of an hierarchy of buses 208 and 210. Subscriber loop 101g can be respectively connected to the access grid 206 by electrically activating a connection point 212. By activating particular connection points, test equipment 172 may probe individual subscriber loops interconnected with grid 206 to determine electrical characteristics of each loop.

FIG. 3 shows the details of the connection point 212. Each line card 202 provides a tip and ring pair of conductors 214 and 216. During normal operation tip and ring pairs 214 and 216 are connected to the tip and ring pairs 218 and 220 of the subscriber loop 101g. This connection is provided at the connection point by relays 222. During testing of the subscriber loop 101g, the tip and ring pair 218 and 220 of subscriber loop 101g is connected to an associated tip and ring pair 224 and 226 of a bus 210 in the access grid 206. This interconnection permits the test equipment 204 to be connected directly to the subscriber loop 101g.

FIGS. 4, 5 and 6 illustrate different methods used to install cables carrying subscriber loops between the central office and subscriber premises. Example methods include buried cable shown in FIG. 4 in which the cable is simply laid in a trench and covered with earth; underground cable shown in FIG. 5 in which the cable is run through a conduit buried in the earth; and, aerial cable shown in FIG. 6 in which the cable is supported by poles above the ground. As will be appreciated, each type of installation requires cable with particular properties.

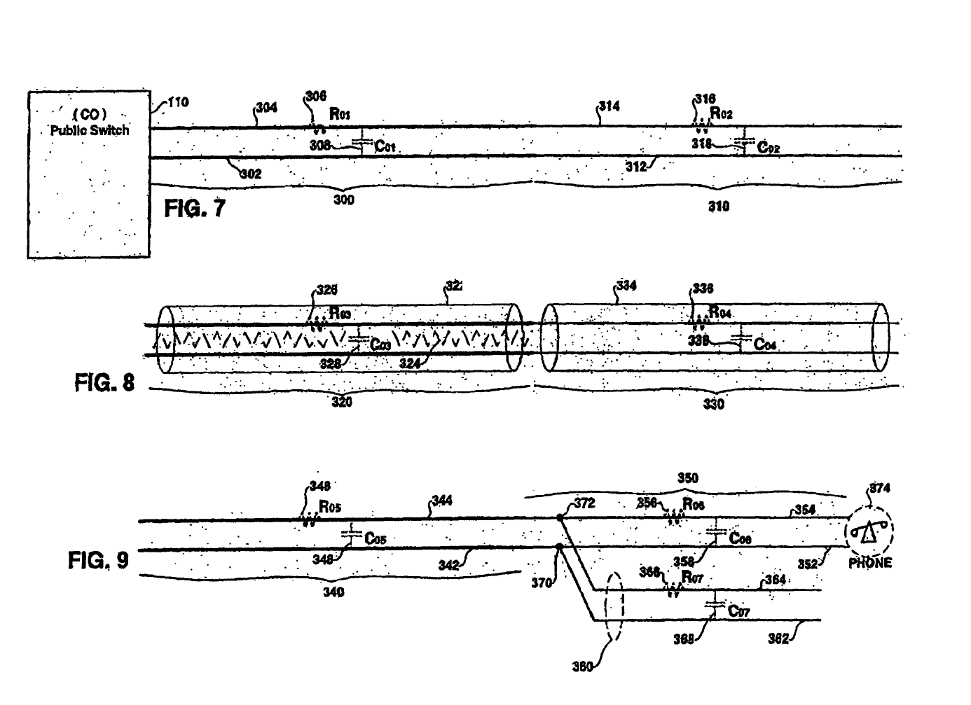

FIG. 7 is a schematic diagram electrically modeling the interconnection of subscriber loop 101g with CO 110. Subscriber loop 101g is made up of two segments. A first segment 300 includes a tip and ring pair 302 and 304 of a first wire gauge. This first segment 300 is characterized by an associated first electrical resistance 306 and first electrical capacitance 308. The second segment 310 is made up of tip and ring pairs 312 and 314 of a second gauge. This second segment is characterized by an associated second electrical resistance 316 and an electrical capacitance 318. FIG. 8 is a schematic diagram of another possible subscriber loop including shielded tip and ring pairs. Subscriber loops segment 320 is shielded by an outer sheath filled with a dielectric insulator 324. This segment is characterized by an electrical resistance 326 and an electrical capacitance 328. Subscriber loop segment 330 is shielded by a sheath 332 that is air filled. This segment is characterized by an electrical resistance 336 and an electrical capacitance 338.

FIG. 9 is a schematic diagram of a further subscriber loop connected to a telephone 374, and including a bridged tap segment 360. In this configuration subscriber loop segment 340 includes a tip and ring pair 342 and 344 having an electrical resistance 346 and an electrical capacitance 348. Loop segment 350 includes a tip and ring pair 352 and 354 having an electrical resistance 356 and an electrical capacitance 358. A bridged tap segment 360 includes a tip and ring pair 362 and 364 having an electrical resistance 366 and an electrical capacitance 368, The bridged tap segment 360 is connected to the loop segment 350 at connection points 370 and 372. As will be appreciated, bridged tap segment 360, effectively divides a single loop segment into two separate loop segments 340 and 350.

In manners exemplary of the present invention, subscriber loops can be qualified for xDSL services on an individual basis, or in groups. For example, an individual subscriber loop could be qualified in response to a request for service by the subscriber. Alternatively, a carrier service provider can elect to qualify a group of subscriber loops (e.g. all of the subscriber loops connected to a particular switch) at a time convenient to the carrier service provider, such as, for example, following an upgrade of a switch to enable DSL services to be provided by the switch.

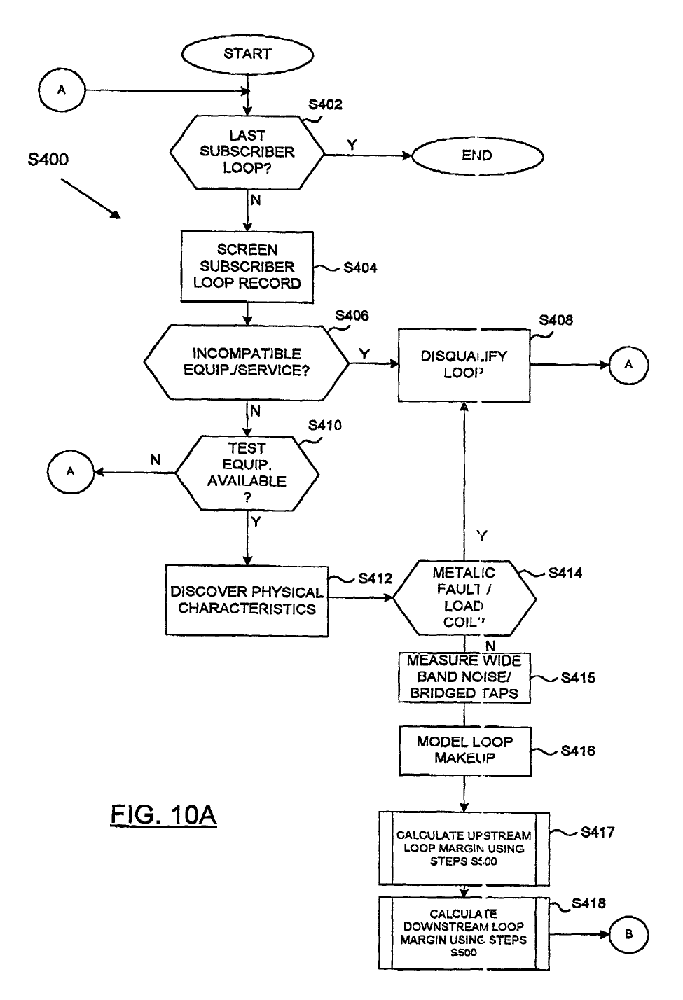

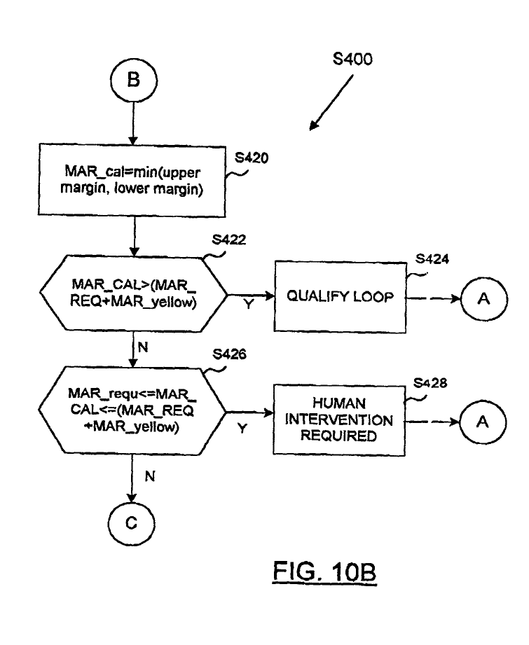

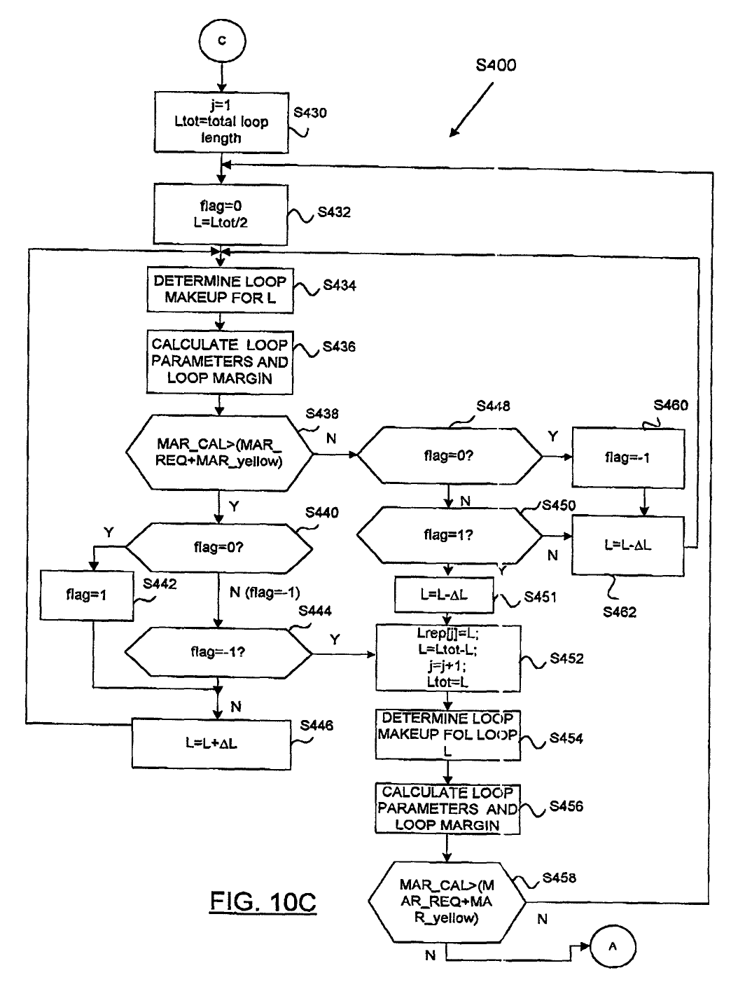

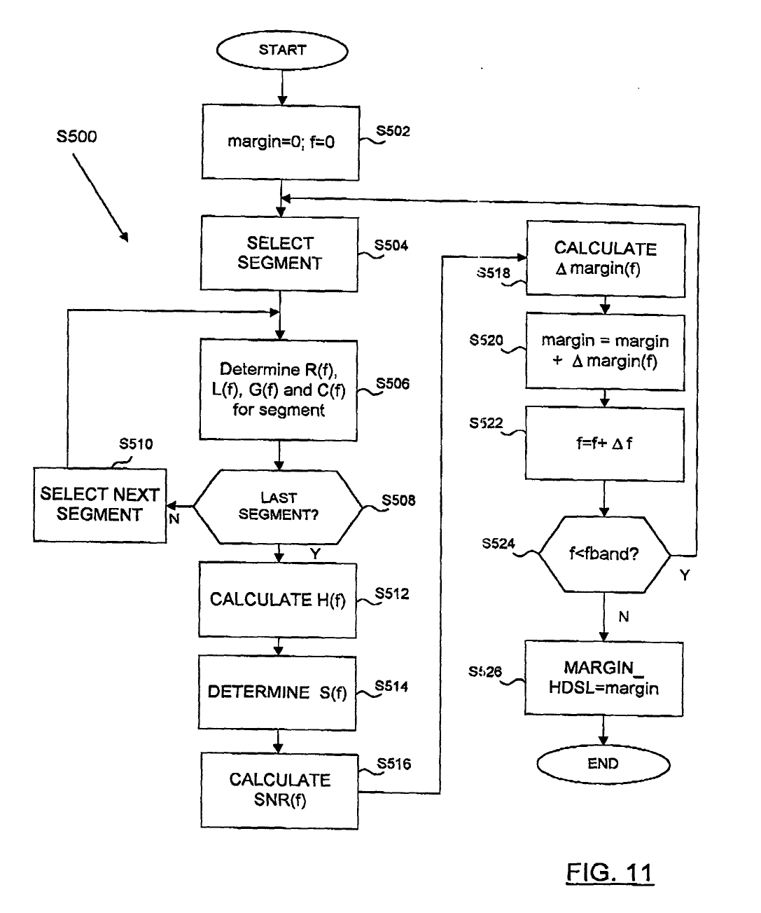

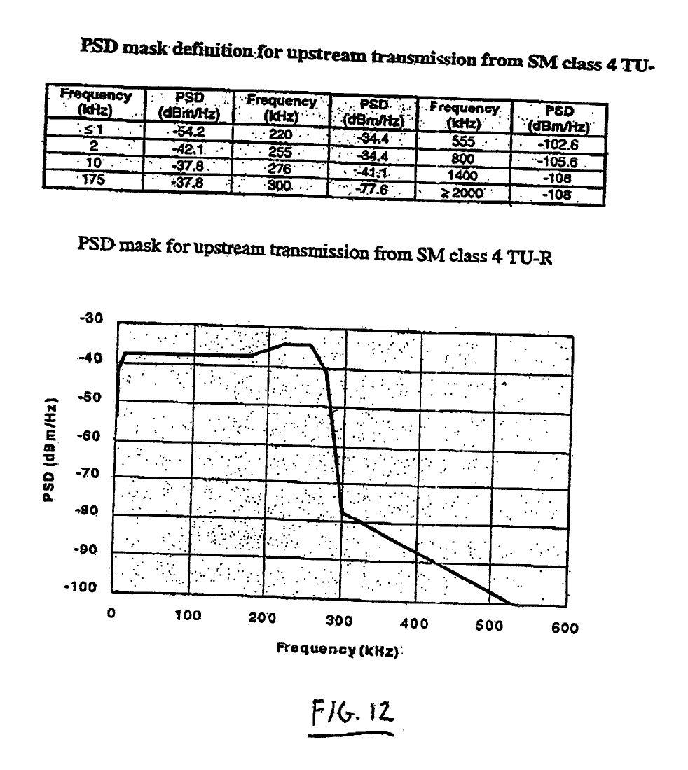

FIGS. 10A-10C and 11 illustrate steps for qualifying one or more subscriber loops for particular types of xDSL service. For the purposes of illustration, the methods of FIGS. 10A-10C and 11 are described with reference to qualifying subscriber loops for xDSL services using technologies that typically require a minimum bandwidth, and therefore typically do not provide adequate service on loops that do not support this bandwidth. Moreover, the xDSL service to be provided may be provided to a subscriber loop, “as is” or to a subscriber loop enhanced with one or more repeaters. Example xDSL technologies that require a minimum bandwidth and support the use of repeater in order to enhance existing loops include IDSL, HDSL and HDSL2. Suitable repeaters for use with HDSL2 are for example available Adtran of Huntsville, Alabama under model number H2R/239.

As illustrated in FIGS. 10A-10C in order to perform the subscriber loop qualification process, processor 100 (FIG. 1) of test system 99 under software control qualifies one or more loops in steps S400 such as subscriber loop 101g. Specifically, in step S402, processor 100 determines whether a last subscriber loop identified in a qualification request list has been qualified. If at least one subscriber loop remains to be qualified, process or 100 queries the carrier service provider database 106, and retrieves a subscriber loop record located using the subscriber directory number, for example. At step S404, the processor 100 screens the customer record to identify any equipment or services on the subscriber loop that may be incompatible with xDSL (typically because they are known to reduce the available bandwidth above voice frequency to zero, or a negligible margin). As noted with reference to FIG. 1, incompatible equipment and services include voice frequency (VF) repeaters, line intercepts, loop extenders, induction neutralizing transformers, added main line (AML) carriers, bridge lifters, and private branch exchange (PBX) services. As noted, FIG. 1 illustrates exemplary subscriber loops 101a-101f equipped with devices and services which preclude the provision of xDSL services.

If any such incompatible equipment or services are found in step S404 for the particular loop under test, processor 100 disqualifies this subscriber loop for xDSL services in steps S406 and S408. Disqualification signifies that xDSL services cannot be deployed on the subscriber loop until (or unless) the incompatible equipment and/or services are removed. Following disqualification of the subscriber loop, the processor 100 records the disqualification in the subscriber loop record, or issues a (justification report, or both. Optionally, the processor may signal a visual or audible alert at an associated display, local or remote to processor 100. Processor 100 selects a next subscriber loop at step S402 and restarts the qualification process.

If no incompatible equipment and/or services are found as determined In step S406, processor 100 determines in step S410 whether test equipment, such as test equipment 172 is available (i.e. at the CO), that is capable of probing the subscriber loop under test to enable discovery of the physical characteristics of this subscriber loop.

If test equipment is not available as determined in step S410, processor 100 ends evaluation of the subscriber loop, because it lacks sufficient information to estimate noise margin. In this case, the processor 100 may provide an indicator of its results, to a log file or display (not shown). Next, processor 100 selects a new subscriber loop at step) S402, and restarts the qualification process.

If test equipment is determined to be available In step S410 the processor proceeds to discovery of the physical characteristics of the subscriber loop in step S412.

Discovery of the physical characteristics of the subscriber loop can be conducted in any of a variety of ways known in the art, depending primarily on the type of test equipment available. For example, the subscriber loop can be probed using test signals to detect the presence of shorts opens, grounds and load coils, as taught by U.S. Pat. No. 4,870,675 (Fuller et al.). Test equipment is also known for probing subscriber loops (through the switch), to measure values of resistance and capacitance over the entire subscriber loop. Using these measurements in conjunction with known cable properties, it is possible to deduce a physical make-up of the subscriber loop.

Test equipment 172 may be connected to the subscriber loop independently of the CO 110 (i.e. on the analogue side of the loop) using a Tellaccord™ manufactured by Tollgrade Communications Inc. This equipment, which is illustrated in FIG. 2, permits measurement of wide-band noise on the subscriber loop upstream of the CO switch As will be appreciated, wide-band noise on the subscriber loop cannot be measured through the switch.

Test equipment 172 is located at CO 110. Thus, wide band noise measurement obtained using test equipment 172 measures the noise of the copper wire at CO end only. This noise measurement is suitable for calculating the upstream noise margin. However, noise that could be measured at the transmission receiver end would be indicative of the downstream noise margin. Test equipment 172, because of its location cannot directly measure noise at the CPE. Thus, to calculate the downstream noise margin, a default noise floor (e.g. −140 dBm/Hz) is assumed. The default −140 dim/Hz approximates a noise free environment. This default noise floor is stored in the database 106 and may be adjusted. When the test equipment 172 is not capable of measuring wide band noise at the CO, the default noise floor (e.g. −140 dBm/Hz) may also be assumed for the calculation of an upstream noise margin.

Alternatively, downstream noise may be approximnated by assuming downstream noise originates at the CO and is attenuated by the subscriber loop. The downstream noise may thus be approximated by using a measure of the upstream noise at CO 110, attenuated by a factor representative of the length of the loop. If this value of downstream noise is greater than the default noise floor, the approximated noise value could be used.

Typically, the subscriber loop record will not contain information of metallic faults or load coils. Accordingly, at step S412, the processor controls the test equipment to probe the subscriber loop to test for metallic faults (e.g. shorts or grounds) and load coils. If either of these conditions are found, the processor disqualifies the subscriber loop in steps S414 and S408 as it cannot support xDSL services until these conditions are resolved.

Next in step S415 processor 100 uses test equipment 172 to make measurements of wide-band noise and to detect any bridged taps on the loop. Bridged taps may for example be detected and located using conventional time domain reflectometry techniques. Using such techniques, the location and length of any bridged tap may be assessed. As a result, in step S416 processor 100 may model the loop makeup based on, (1) the loop length derived from the capacitance value from metallic loop test; (2) the bridged tap information; and (3) the default information setup in the database 106.

specifically, the subscriber loop record in database 106 for each subscriber loop contains information about the physical characteristics of the subscriber loop and services deployed on the loop. As described above, the information regarding physical characteristics preferably includes the identity (type) of equipment installed for the subscriber loop. The information also preferably provides data describing the make-up of the loop including a length, gauge size, insulation type and installation type for each cable segment (see FIGS. 7-9) forming the subscriber loop, as well as best and worst case constitutions for each subscriber loop. Example information stored within the database for subscriber loops is reproduced in the following table:

TABLE 1

| | | | | | | | | | LRG. | SM. | % | % |
|---|---|---|---|---|---|---|---|---|---|---|---|---|
| NEI | SITE | | | | | | L. | SM. | GGE | GGE. | LG. | SM. |
| CODE | NAME | REGION | DIST. | INSUL. | INSTALL | GGE. | GGE | GGE | FILL | FILL | GGE | GGE |
| DMU00 | HOST | R1 | 10 | PIC | U | 24 | 24 | 26 | A | A | 70 | 80 |
| DMU00 | HOST | R1 | 10 | PIC | U | 24 | 24 | 26 | A | A | 100 | 100 |
| DMU00 | HOST | R1 | 10 | PIC | U | 19 | 24 | 26 | A | A | 100 | 100 |
| DMU02 | HOST | R1 | 10 | PIC | U | 24 | 24 | 26 | A | A | 100 | 100 |
| DMU02 | HOST | R1 | 10 | PIC | U | 19 | 24 | 26 | A | A | 100 | 100 |
| DMUNO | HOST | R1 | 10 | PIC | U | 19 | 24 | 26 | A | A | 100 | 100 |
| COIL | | | | | | | | | | | | |
| DMUSIM | HOST | R1 | 10 | PIC | U | 19 | 24 | 26 | A | A | 100 | 100 |
| J_IMAS | HOST | R1 | 10 | PIC | U | 19 | 24 | 26 | A | A | 100 | 100 |
| NEWTO | HOST | R1 | 10 | PIC | U | 24 | 24 | 26 | A | A | 100 | 100 |
| NA00 | | | | | | | | | | | | |
| RTLINE | HOST | R1 | 10 | PIC | U | 19 | 24 | 26 | A | A | 100 | 100 |
| TESTING | HOST | R1 | 10 | PIC | U | 19 | 24 | 26 | A | A | 100 | 100 |

In the example table,

NEI CODE and SITE NAME describes the telephone CO or digital subscriber loop access multiplexer(“DSLAM”) that a subscriber loop is associated with.

REGION: defines geographically where the CO is. Another table (not shown) defines the highest temperature of each region during a year. This field and install field will determine the temperature of the cable, i.e. the temperature when determining RLGC values for a cable, as detailed below.

DISTANCE is the distance between a xDSL circuit to the main distribution frame (MDF) In an associated CO. when loop length is measured as described below, the measurement reflects a length between the MDF and the CPE. It does not include the loop length between the xDSL circuit to the MDF, which is therefore preferably defined here.

INSULATION is the type of insulation of the cable. PIC, for example, represents plastic insulation; PULP represents paper insulation.

INSTALL is the cable installation method Where U means underground. B means buried in the soil. A mearis aerial. The type of installation contributes to the determination of th(e highest temperature of the cable.

GAUGE (GGE) is the default wire gauge between the xDSL circuit to MDF.

LARGE GAUGE is the default thick wire gauge.

SMALL GAUGE is the default thin wire gauge.

LARGE GAUGE FILL is the filling of the cable for the large wire gauge.

It can be either air filled (with A in the field) or jelly filled (with J in the field).

SMALL GAUGE FILL is the filling of the cable for the small wire gauge.

% LARGE GAUGE means that in the best case, the percent of the large wire gauge in the loop.

% SMALL GAUGE means that in the worst case, the percent of the small wire gauge in the loop.

Of course, other information about a subscriber loop, useful to qualify the loop, may be stored in database 106 and may form part of the above table or another table (not illustrated) associated with the subscriber loop.

So, in the example table (TABLE I), a subscriber loop associated with the first record in the table, includes a large gauge 24 AWG (American Wire Gauge) and small gauge 26 AWG wire. For a loop length of 10000 feet, in the best case, the loop length with the large wire gauge is 70%×10000=7000 feet; and the small wire gauge in the best case is 10000−7000=3000 feet. In the worst case, the loop length with the small wire gauge is 80%×10000=8000 feet; the large wire gauge in the worst case is 10000−8000=2000 feet.

Next, processor 100 completes the discovery of the physical characteristics of the subscriber loop by assessing noise margin for the loop, and thereby available bandwidth in steps S417 and S418 using substeps S500 detailed in FIG. 11.

Specifically, as illustrated, steps S500 allow processor 100 of test system 99 to assess a noise margin for a given bandwidth for a subscriber loop formed of segments. The noise margin reflects an estimate of whether the total bandwidth available for wide-band xDSL signals transmitted over the subscriber loop is adequate. In the example embodiment, processor 100 attempts to qualify a loop for a symmetric xDSL service such as HDSL2. Of course, the invention could be used to qualify loops for other services.

FIG. 11 illustrates in greater detail step S500 of determining if sufficient bandwidth may be provided by a loop, exemplary of an embodiment of the present invention. As will be appreciated by those of ordinary skill, the bandwidth (or bit-rate of data transmission) available on a subscriber loop (or any portion thereof) can be calculated from the signal-to noise ratio (SNR) of the subscriber loop at various frequency.

The SNR at a particular frequency can, in turn, be calculated from values of resistance (R), inductance (L), conductance (G) and capacitance (C) of the loop. Additionally, the values of R, L, G, and C are primarily functions of physical properties of the cable (e.g. conductor gauge (size), insulation type, and temperature) and may also vary with frequency.

Specifically, the SNR for the subscriber loop as a function of frequency can be calculated using known techniques, such as described in Draft Proposed American National Standard, Spectrum Management for Loop Transmission Systems, ANSI T1E1.4/2000-002R4.

For an HDSL2 loop,

$$f\_SNR ( f ) = {\sum }_{n = - 2}^{1} \frac{S ( f + fbaud \times n ) {\vert H ( f + fbaud \times n ) \vert}^{2}}{N ( f + fbaud \times n )}$$

Where S represents the signal strength on the loop; |H|² represents the magnitude squared of the loop insertion gain transfer function; N represents a measurement of wide-band noise; and fbaud represents the total bandwidth required for HDSL2 as detailed below.

Accordingly, a subscriber loop under test is considered to be divided into one or more cable segments having a respective combination of length, conductor gauge, insulation type, and installation type at different temperatures. This permits values of R, L, G, and C to be found for each cable segment, which can be aggregated to calculate the SNR, as illustrated in FIG. 11.

Specifically in step S502, processor 100 begins by setting temporary calculation values of frequency and a noise margin tally to zero. Next, processor 100 determines characteristics electrical characteristics for a particular segment at a given frequency f in step S506. The segment may reflect an actual segment of the loop, as detailed in record 106, or alternatively a portion of a theoretical loop, as described below. In any event, based on the contents of an associated record of database 106, processor 100, finds values of R(f), L(f), G(f), and C(f) for the segrnent at the provided frequency (f). These values can conveniently be found by performing a look-up function in a cable properties database (not shown), which provides representative values of R, L, G, and C for each combination of conductor gauge and insulation type, measured at specific temperatures. An exemplary table of the cable properties database is as follows:

TABLE II

| | | | | |
|---|---|---|---|---|
| gauge | 26AWG | | | |
| Insulation | PIC | | | |
| temp. | 70° F. | | | |
| Frequency | R | L | G | C |
| . . . | . . . | . . . | . . . | . . . |
| 20000 | 83.48 | 0.1868 | 0.295 | 15.72 |
| . . . | . . . | . . . | . . . | . . . |
| 30000 | 83.8 | 0.1854 | 0.295 | 15.72 |
| . . . | . . . | . . . | . . . | . . . |

The data stored in the cable properties database may be supplied by a cable manufacturer and/or obtained from reference texts. such as, for example the Digital Subscriber Loop Signal and Transmission Handbook, Whitman B. Reeve, IEEE Telecommunications Handbook Series, 1995. In order to extract the appropriate data from the cable properties database, the processor 100 uses the installation type (e.g. aerial, buried, or underground) from the customer record to determine a temperature parameter applicable to the selected cable segment (s), as stored in the database 106. Exemplary temperature parameters are as follows:

| Installation type | temperature parameter |
|---|---|
| Aerial | T(s) = Maximum temperature at CO + 30° F. |
| Buried | T(s) = (Maximum temperature at CO) − 10° F. |
| Underground | T(s) = 68° F. |

Using the temperature parameter, in combination with the conductor gauge, and insulation type of the selected cable segment (s), values of R, L, G, and C can be extracted from the cable properties database for temperatures bracketing (i.e. above and below) the temperature parameter. Values of R(f), L(f), G(f), and C(f) for the selected cable segment (s) can then be approximated from the extracted values by using known interpolation techniques.

Specifically, measured capacitance values (tip to ground and ring to ground) and cable filling (air core or jelly filled) as recorded in Table I and stored in database 106 may be used to calculate the loop length, Lₜₒₜₐₗ (this loop length includes any bridged taps). For example, if The cable is air core cable, 15.7 nF/kft may be used(L=0.2/15.7×1000=12.74 kft). If the cable is jelly filled, 17.6 nF/kft is used (L=0.2/17.6×1000=11.36 kft). Of course, as the defined constants (15.7 and 17.6) are stored in the database they may be adjusted.

Using an the assessment of bridged taps made in step S416 the loop length may be approximated. That is, if there are no bridged taps in the loop, the actual loop length, L_{act}=Lₜₒₜₐₗ. Otherwise, L_{act}=Lₜₒₜₐₗ−total bridged tap length. Two cable wire gauges are assumed.

TABLE I, above, allows the length of each cable segment, its wire gauge, installation method, the highest environment temperature of the area and the insulation type to be assessed. This allows R, L, G, C to be determined.

In step S508, the processor determines whether values of R(f), L(f), G(f), and C(f) have been found for all of the cable segments (s) forming the subscriber loop or portion of the theoretical loop of interest. If the result of this determination is “NO”, then the processor selects the next cable segment (in step S510) and repeats steps S506 and S508. If there is no bridged tap in the loop, there will be two cable segments, one from the subscriber line card to the MDF, and one from the MDF to the CPE.

That is, without a bridged tap, the first loop segment is from the xDSL line card to the MDF (defined in TABLE I, above, column “dist”). The remainder of the loop may contain one or two additional segments. This may be determined with reference to Table I. That is, if % large gauge for a loop is 100% and % small gauge is also 100% the loop contains 100% of the same gauge wire (typically 24 AWG cable), and therefore only one segment between the MDF and CPE. If % large gauge and % small gauge differ, in Table I, the total loop segments between the MDF and CPE may be assumed to equal at least two.

If there are bridged taps in the loop, each bridged tap will divide a cable segment into two. That is, a segment without a bridged tap is split by the bridged tap. So for example, an otherwise integral segment with two bridged taps will be divided into three segments. As well, the bridged taps are treated as segments. Thus, the total number of segments for su(h a loop will equal five.

When values of R(f), L(f), G(f), and C(f) have bee n found for all of the cable segments forming the subscriber loop, processor 100 calculates in step S512 an insertion loss for the subscriber loop at the selected frequency (f).

As an intermediate step, the values of R(f), L(f), G(f), and C(f) can be used to calculate values of A(s), B(s), C(s), and D(s) for each cable segment at the frequency of interest. This is, for example, detailed in ADSL/VDSL Principles: A Practical And Precise Study of Digital Subscriber Line and Very High Speed Asynchronous Digital Subscriber Line, by Denis J. Rauschmayer, Macmillan Technical Series, 1999, (hereafter “ADSL/VDSL Principles”). For a cable segment, values of A(s), B(s), C(s), and D(s) are given by:

$$A ( s ) = Cos h ( P \times l )$$

$$B ( s ) = Sin h ( P \times l ) \times I$$

$$C ( s ) = \frac{Sin h ( P \times l )}{I}$$

$$D ( s ) = A ( s )$$

$$where : \\ P = \sqrt{( R + j ω L ) \times ( G + j ω C )} ( the Propagation Constant )$$

$$I = \sqrt{\frac{R + j ω L}{G + j ω C}} ( the Characteristic Impedance ) , and$$

$$l is the cable segment length .$$

The loop length (I) may be derived from the capacitance measured between tip-ground and ring-ground from the metallic loop measurement and the bridged tap detection.

Similarly, the loop makeup including the wire gauge, installation method (aerial, underground or buried), the highest environment temperature of the area, the insulation of the cable pair (plastics or paper) and cable filling (air core or jelly filled) may be used in the above calculations. This information may be stored in database 106.

For the purposes of these calculation, a bridged lap can be treated, as a virtual cable segment disposed between adjacent cable segments. In the case of a bridged tap, values of A, B, C, and D are given by:

A(bt)=1

B(bt)=0

$$A ( bt ) = 1$$

$$B ( bt ) = 0$$

$$C ( bt ) = \sqrt{\frac{R + j ω L}{G + j ω C}} \frac{1}{Cot h ( P \times L )}$$

$$D ( bt ) = 1$$

D(bt)=1

These values of A, B, C, and D for each cable section may then be combined to find values of A, B, C and D for the entire subscriber loop at the frequency of interest (f). Thus:

$$[ \begin{matrix}A & B \\ C & D\end{matrix} ] = [ \begin{matrix}A 1 & B 1 \\ C 1 & D 1\end{matrix} ] \times [ \begin{matrix}A 2 & B 2 \\ C 2 & D 2\end{matrix} ]$$

It should be noted that, in this calculation of A, B, C and D for the entire subscriber loop, the order of calculation of the segment matrices follows the order in which the cable segments are arranged on the subscriber loop (in a direction moving away from the CO). Thus where the subscriber loop includes a bridged tap, the matrix of A(bt), B(bt), C(bt) and D(bt) values will be arranged between the corresponding matrices of the adjacent cable segments.

From the values of A, B, C and D for the entire subscriber loop, the loop insertion loss (preferably based on the assumed 135 ohm termination for HDSL2) can be found in step S512, using techniques described in ADSL/VDSL Principles, supra. Specifically, with ABCD values, the loop insertion loss can be obtained as follows:

|1/H(f)|²=|A*Z_{L}+B+Z_{G}*(C*Z_{L}+D)/(Z_{G}+Z_{L})| Where Z_{L}, Z_{G} is the load impedance. For HDSL2, Z_{L}, Z_{G} is 135 Ω. f is the frequency in Hz.

Once the loop insertion loss has been calculated the upstream SNR for the loop at the particular frequency may be calculated, based on the upstream transmission power; a wideband noise measurement, as for example performed as part of step S415; and the loop insertion loss.

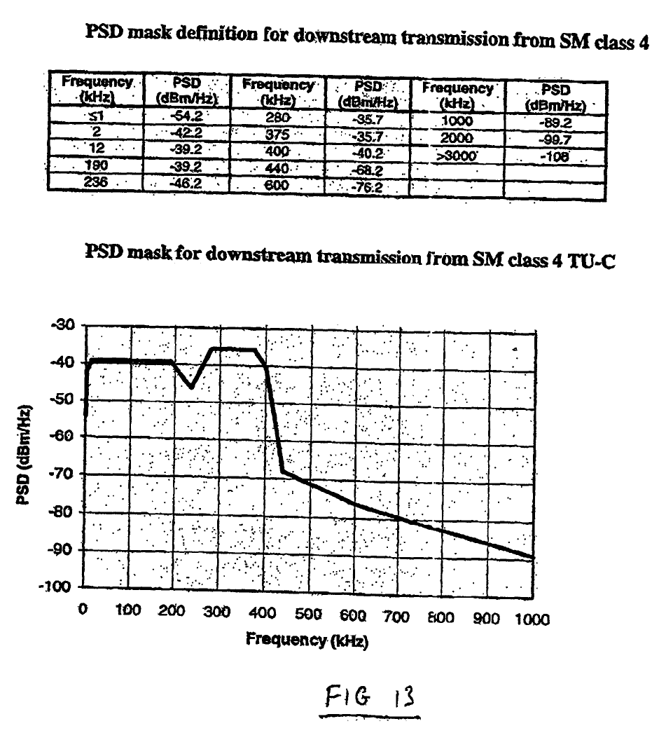

As will be appreciated, the transmission power for a given frequency will vary in accordance with the defined power spectral density for HDSL2, as described in Draft proposed American National Standard, Spectrum Management for Loop Transmission Systems from ANSI T1E1.4/2000-002R4. For convenience, the upstream power spectral density is reproduced as FIG. 12. Thus, in step S514, for the particular frequency the transmission power may be determined using stored values.

Now, as noted the SNR for the loop at the particular frequency (f) may be calculated in step S516 in accordance with,

$$f\_SNR ( f ) = {\sum }_{n = - 2}^{1} \frac{S ( f + fbaud \times n ) {\vert H ( f + fbaud \times n ) \vert}^{2}}{N ( f + fbaud \times n )}$$

Experimentally, it has been concluded that for ease of calculation, the SNR may be approximated as

$$f\_SNR ( f ) = \frac{S ( f ) {\vert H ( f ) \vert}^{2}}{N ( f )}$$

From the calculated or approximated SNR for each frequency, the total upstream HDSL2 noise margin may be calculated in accordance with Draft Proposed American National Standard, Spectrum Management for Loop Transmission Systems from ANSI T1E1.4/2000-002R4, Section A.2.2. Specifically,

$$Margin = \frac{1}{fbaud} {\int }_{0}^{fbaud} 10 * log 10 ( 1 + f\_SNR ( f ) ) ⅆ f - SNR\_req ⅆ B$$

Integration may be performed at processor 100 numerically, using conventional techniques. A simplified margin may be calculated repeating steps S504-S518, and summing the margin at 4000 Hz intervals, assuming that H, N and S and thus the SNR throughout each frequency interval is constant (as approximate at the center of the interval). This is effected by steps S520-S524, so that a final MARGIN HDSL may be assessed in step S526.

The downstream noise margin is similarly calculated in step S418 (FIG. 10A) using steps S500. However, the transmission power used for the calculation is used for the downstream power spectral density, as depicted in FIG. 13. Moreover, as measurements are performed at the CO, wide-band noise in the downstream direction cannot be directly measured. Instead, it is approximated using a value that may be stored in database 106 for the particular loop. For example, a value of −140 dBm/Hz may be used.

It is worth noting that in the calculations performed in steps S400 and S500, only the insertion loss is dependent on the actual length of the loop. Noise measurements/approximations may be assumed to be independent of the actual length of loop.

Upon assessing the bandwidth of the loop, and the corresponding loop margin for upstream and downstream signal, in steps S417-S418, the processor proceeds to attempt to qualify the loop in steps S420-S428. as illustrated in FIG. 10B.

Now, for the purposes of qualifying the loop for HDSL2 service, an assessment is made in step S422 to determine if the minimum calculated loop margin (MAR_cal—determined as the minimum of upstream and downstream noise margins in step S420)

MAR_cal>=(MAR_REQ+MAR_yellow),

Where MAR_yellow is a comfort margin above the minimum margin required for the loop. If so, the loop under test is qualified for HDSL2 service in step S424. A suitable MAR_REQ may equal 6 dB.

MAR_yellow provides a comfort zone. If, over time, the loop deteriorates, the attenuation of the loop will be higher. In this case, if the loop was qualified with MAR_REQ (usually 6 dB), the loop can still support HOSL2 service. Since the loop makeup is based on the loop measurements (capacitance and bridged tap) as well as the statistic information defined in the screen display, it is an approximation. MAR_yellow (say defined as 3 dB) is provided such that if 6 dB<=MAR_cal<9 dB, this loop may or may not be qualified.

If not, an assessment is made in step S426, if

MAR_REQ<=MAR_cal<(MAR_REQ+MAR_yellow).

If so, the loop is conditionally qualified in step S428. However, human intervention may be required to assess whether the loop truly qualifies. As well, this condition may indicate that the loop could qualify if the loop is modified by placing a repeater in line.

If MAR_cal<MAR_REQ as determined in step S426, the loop Will not qualify without modification.

Accordingly, in order to assess if the loop may qualify with modification, a loop modified with a number of repeaters is modelled in a manner exemplary of the present invention. The locations of the repeaters will be determined, as described below. As will become apparent, the location of each repeater is chosen to provide at least the minimum acceptable noise margin between repeaters, and between the CO and the first repeater. That is the location of each repeater is chosen, so that loop portions between repeaters would qualify for xDSL service—each loop segment has a sufficient noise margin so that xDSL signals may be exchanged between repeaters.

Optionally, the method may provide the minimum required noise margin between the last repeater and the CPE for the number of repeaters used. Further, the margin of each loop portion (between repeaters) is preferably evenly spread. To achieve this, the distance between each two adjacent repeaters and the distance between the first repeater and CO is decreased until the loop portion has the required noise margin, and the distance between the last repeater and CPE is increased.

Specifically, exemplary steps S430 to S464 detailed in FIG. 10C are performed. Temporary values of a counter j is set to 1, and a flag flag are set to 0 in step 8430 and S432. In step S432, the initial length of a theoretical loop is calculated as equaling the total loop length divided by two. In step S434, the theoretical loop makeup for a loop portion of this length is calculated (using the loop makeup modeled in step S416) and the upstream and downstream noise margin are calculated using steps)s S500 (FIG. 11) in step S436 (in much the same way S417-S420 (FIGS. 10A and 10B)). Specifically, steps S500 are used to calculate the upstream and downstream noise margin; the least of the two is used in step S438. If this theoretical loop portion qualifies, as determined in step S438, a new loop portion having a length ΔL longer is modeled in step S446, and the calculation is repeated by repeating steps S434 and onward. The variable flag is Set to 1 in step S442 to indicate that the loop portion length is being increased, ΔL may be chosen to have a value of five to ten percent of the total loop, depending on the accuracy desired by an operator of system 99. In this way, steps S434 and onward are repeated for loop portions of incrementally longer length, until a loop portion of length L is determined not to qualify in step S438. Now as the value of flag=1, the value of L is reduced by ΔL in step S451, so that L will have the value of the longest qualifying loop portion in Step S452. Thus, an initial loop portion of length L from the CO would qualify for xDSL service, and the value of L is stored as the location of the first repeater. Thus, in step S452 the location of the first repeater is stored in Lrep[0]. Steps S454 and onward are performed to ensure that the remainder of the loop would qualify with a single repeater. Specifically, the makeup of the remainder of the loop is determined in step S454, and its noise margin is determined using steps S500 in step S456. Again in step S456 the upstream arid downstream noise margin is calculated using steps S500 (FIG. 11) (in much the same way S417-S420 (FIGS. 10A and 10B)), and used in step S458. If the remainder qualifies, the position of the first and only repeater is stored in Lrep[0] in step S452. If the remainder of the loop does not qualify without an additional repeater as determined in step 5458, the remainder of the loop is divided into two portions in step S432, and steps S434 and onward are repeated for the remaining portion of the loop (as divided in half). Appropriate repeated positions for additional repeaters will be stored at Lrep[1] . . . Lrep[n−1], in step S452, where n is the number of repeaters required for the loop, until the final portion of the loop qualifies as determined in step S458.

In the event, that a loop of half the total length would not initially qualify as determined in step S438, the value of flag is toggled from 0 (as determined in step S448) to −1 in step S460 (signifying that the loop portion is being shortened) and the theoretical portion portion is shortened by ΔL in step S462 and step S434 and onward are repeated. The length of the loop is continually shortened by a value of ΔL since flag=−1 and as a result of steps S448, S450 and S462, until the length of a minimum qualifying loop portion is determined in step S438. Thereafter, steps S452 and onward are performed for the remaining loop portion, to ensure that the remainder of the loop qualifies, or to determine it should be provisioned with repeaters at Lrep[1] . . . Lrep[n−1], as described above.

Once locations of suitable repeaters are found ad stored in Lrep[0] . . . Lrep[n-1], an associated record for the subscriber loop In database 106 may be updated, and steps S402 may be repeated for additional loops. At a later time, the contents of database 106 may be used to mollify/enhance existing loops to include any required repeaters.

The modelled theoretical loop characteristics determined in step S434 for loop portions are average characteristics based on lest and worst case electrical characteristics for the loop stored within database 106. For example, the stored loop characteristics will typically include an indicator of the percentage of the length of the loop formed from lower (e.g. 24 AWG) gauge wire, and a percentage of the length formed from a higher (e.g. 26 AWG) gauge wire. Average theoretical loop properties may be formed by averaging the length of best and worst case lengths of the loop formed of 24 and 26 gauge wire.

For example, assume that loop 101g (FIG. 1) has a length of 5000 m. Assume further that the best case data within database 106 indicates that the total length of the loop 101g may be formed 20% of 26 gauge wire, and 80% of 24 gauge wire, and the corresponding worst case data indicates that the length may be formed of 70% 26 gauge wire and 30%. 24 gauge wire. Processor 100 in step S434 accordingly calculates average loop characteristics of a theoretical modeled loop formed of 45% 26 gauge wire, and 55% 24 gauge wire. Further processor 100 assumes that the first portion of the theoretical loop to be tested in step S436 will be formed of the higher gauge wire. Thus, for the purposes of steps S436 and steps S500, processor 100 assumes that the first portion of the theoretical loop), will have a length of 2500 m and will be formed of (0.45*5000)=2250 m of 28 gauge wire, and 250 m of 24 gauge wire. If this first portion qualifies, the theoretical loop portion may be increased in size by ΔL and steps S432 and onward may be repeated, as described above. Each time step S434 is performed, the average makeup of the loop, as stored in database 106, may be taken into ,account. In the event the example loop portion does not initially conditionally qualify, steps S434 and onward are repeated assuming the initial repeater will be placed ΔL closer to the CO, until the initial portion of the loop qualifies. So, assuming ΔL=250 m (=5% total length) a theoretical loop portion having of the 45% of the actual loop length (ie. 2250 m) is tested. If this portion would qualify, the remaining portion of the loop is tested in steps S452, as; described above. In any event, at the conclusion of steps S462, the variables L[0] . . . L[n−1] will store the appropriate locations for repeaters. These values may be used to update a record within database 106 associated with the loop.

Steps 400 illustrated in FIGS. 10A to 10C approximate repeater locations providing the minimum acceptable margins between the first repeater and the CO as well as between adjacent repeaters. As well, the final loop portion between the final repeater and the CPE will have the maximum noise margin (i.e. a minimum margin and an excess margin). To further improve the capability of the margin for the entire loop, the excess margin could be spread to each loop portion (between repeaters). To achieve this, the distance between each two adjacent repeaters as well as the distance between the first repeater and CO could be decreased, and the distance between the final repeater and CPE could be increased.

Accordingly, upon completion of step S458 (FIG. 10C) the locations of repeaters could be further adjusted to distribute the excess loop margin across loop portions. For example, if a loop has no bridged taps, the excess margin could be converted to an excess length of the final loop portion (i.e. a length by which the last loop portion could be extended while still meeting margin requirements. The location of the repeaters could then be adjusted equally toward the CO, with each repeater moved closer to an adjacent repeater by a fraction of the total excess loop length, in an upstream direction, toward the CO.

Conveniently, then methods exemplary of the present invention may be used to determine whether an enhanced loop including a suitable number of repeaters would qualify for HDSL2 service.

Although a specific theoretical modeled loop has been described in order to assess if an actual loop will qualify, if modified with repeaters, a person of ordinary skill in the art will readily recognize other models that may be used to assess if a suitably modified loop may qualify. For example, actual loop parameters could be used to assess if an initial portion of a loop may qualify for xDSL service.

Of course, the above described embodiments, are intended to be illustrative only and in no way limiting. The described embodiments of carrying out the invention, are susceptible to many modifications of form, arrangement of parts, details and order of operation. The invention, rather, is intended to encompass all such modification within its scope, as defined by the claims.

The embodiments of the invention described above are intended to be exemplary only, the scope of the invention being limited solely by the scope of the appended claims.

What is claimed is:

1. A method of assessing if a subscriber loop qualifies for xDSL service, the subscriber loop being connected to a public switched telephone network (PSTN) by a switch at a central office (CO), said method comprising:
modeling a loop representative of said subscriber loop based on electrical characteristics of said subscriber loop determined at said CO to assess performance of said loop when modified with at least one repeater;
estimating if said subscriber loop when modified with at least one repeater provides a bandwidth suitable for said xDSL service, using said model.

2. The method of claim 1, further comprising estimating from said CO end that said subscriber loop does not provide a bandwidth suitable for said xDSL service without a repeater.

3. The method of claim 1, wherein said xDSL service is HDSL2.

4. The method of claim 1, wherein said estimating comprises approximating if a noise margin of a portion of said modeled loop upstream of a first repeater is sufficient for carrying xDSL signals.

5. The method of claim 4, wherein said estimating comprises approximating if a noise margin for each portion of said modeled loop between repeaters is sufficient for carrying xDSL signals.

6. The method of claim 5, wherein said estimating comprises estimating that each portion of said loop between repeaters has a noise margin sufficient for carrying xDSL signals.

7. The method of claim 4, further comprising screenings a subscriber loop record of a carrier service database to assess at least one of said electrical characteristics of said loop to approximate said noise margin for said each portion of said modeled loop between repeaters.

8. The method of claim 7, wherein said subscriber loop record comprises information about devices connected to said subscriber loop and services deployed on said subscriber loop, and said screening comprises disqualifying said subscriber loop for xDSL service if any one of a set of predetermined disqualifying conditions are associated with the subscriber loop.

9. The method of claim 8, wherein the set of predetermined disqualifying conditions comprises: an intercepted line on said subscriber loop; an existing service on the subscriber loop that is incompatible with xDSL services; and a device installed on said subscriber loop that is of a type which prevents transmission of xDSL signals.

10. A computer implemented method of qualifying a subscriber loop, provisioned with at least one repeater for xDSL service, the subscriber loop being connected to a public switched telephone network (PSTN) by a switch at a central office (CO), said method comprising:
determining a first location for a repeater on said loop upstream of said CO, so that a portion of said loop between said CO and said first repeater qualifies for carrying xDSL signals.

11. The method of claim 10, wherein said determining comprises determining a location on said loop defining a loop portion having a noise margin sufficient for carrying said xDSL signals.

12. The method of claim 10, wherein said determining comprises assessing a noise margin of multiple locations along said subscriber loop until said first location having a sufficient noise margin is determined.

13. The method of claim 10, further comprising assessing a maximum distance of said first repeater from said CO.

14. The method of claim 10, further comprising determining locations of subsequent repeaters on said loop, so that each loop portion between adjacent ones of said repeaters qualifies for transporting said xDSL signals.

15. A system for qualifying a subscriber loop for xDSL services if provisioned with at least one repeater, the subscriber loop being connected to a public switched telephone network (PSTN) at a central office (CO), the system comprising a processor operable to:
determine, from a CO end of the subscriber loop, one or more electrical characteristics of said subscriber loop; and
estimate if said subscriber loop when modified with at least one repeater provides a bandwidth suitable for said xDSL service, using said characteristics of said subscriber loop determined by said processor.

16. The system of claim 15, wherein said processor is further adapted to screen a subscriber loop record of a carrier service database for said subscriber loop.

17. The system of claim 16, wherein said subscriber loop record includes information about any one or more of devices connected to said subscriber loop and services deployed on said subscriber loop, and said processor is adapted to disqualify said subscriber loop for xDSL services if at least one predetermined condition is associated with said subscriber loop.

18. The system of claim 17, wherein said predetermined disqualifying conditions comprises at least one of an intercept on the subscriber loop; an existing service on the subscriber loop that is incompatible with xDSL services; and, a device installed on the subscriber loop that is of a type which prevents transmission of wide band xDSL signals.

19. A computer readable medium storing processor executable instruction, that when loaded at a test system including a processor, adapt said processor to assess if a subscriber loop connected to a public switched telephone network (PSTN) by a switch at a central office (CO) to deliver xDSL services to a customer upstream of said CO, if provisioned with at least one repeater qualifies for xDSL services, by:
approximating if a noise margin of a portion of said subscriber loop upstream of a first of said at least one repeater is sufficient for carrying xDSL signals.

20. The computer readable medium of claim 19, wherein said approximating comprises calculating an xDSL noise margin for said portion.

21. A method of determining locations along a subscriber loop for placing repeaters, so that said subscriber loop when provisioned with repeaters qualifies for xDSL services, the subscriber loop being connected to a public switched telephone network (PSTN) by a switch at a central office (CO), said method comprising:
determining a first one of said locations at a maximum distance from said CO, so that a portion of said loop from said CO to said first location has a noise margin sufficient to provide xDSL service.

22. The method of claim 21, further comprising
determining subsequent locations for repeaters along said loop, so that each loop portion between two repeaters has a noise margin sufficient to provide xDSL service.
